(19) United States
(12) Patent Application Publication
(10) Pub. No.: US 2007/0192703 A1
(43) Pub. Date: Aug. 16, 2007

(54) Organizing digitized content on the Internet through digitized content reviews

(76) Inventor: Ron K. Unz, Palo Alto, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/704,551

(22) Filed: Feb. 9, 2007

Related U.S. Application Data
(60) Provisional application No. 60/772,190, filed on Feb. 9, 2006.

(51) Int. Cl. G06F 3/00; G06F 17/00; G06F 7/00

(52) U.S. Cl. 715/733; 715/513; 707/102

(57) ABSTRACT

In an embodiment, a method comprises creating and storing, in a database, first records representing reviews of one or more content items, wherein each of the first records comprises a field or associated index which directly or indirectly uniquely specifies a list of content item identifiers for content items that are reviewed in the review of that record; creating and storing, in the database, second records representing the content items, wherein each of the second records comprises a field or associated index which directly or indirectly uniquely specifies a list of review item identifiers for reviews that review the content item of that record; receiving, from a requesting computer, a request to display a summary web page associated with one of the reviews; in response to the request, generating a summary web page and providing the summary web page over a network to the requesting computer, wherein the summary web page comprises descriptive information about the requested review, and zero or more hyperlinks to electronic files that store the digitized forms of the content items identified in the second records, wherein the hyperlinks are dynamically generated based on the content item list uniquely specified by the first record. In an embodiment, a database stores records of reviews that are massively cross-linked to records of content items reviewed in the reviews, and pages can be dynamically generated to display the reviews and links to digitized files containing the reviews and the reviewed content items.

### CROSS-REFERENCE TO RELATED APPLICATIONS; PRIORITY CLAIM

This application claims benefit of Provisional Appln. 60/772,190, filed Feb. 9, 2006, the entire contents of which is hereby incorporated by reference as if fully set forth herein, under 35 U.S.C. § 119(e).

### FIELD OF THE INVENTION

The present disclosure generally relates to data processing. The invention relates more specifically to methods of organizing and presenting digitized books and other content material on the Internet.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Over the past forty years there have been numerous efforts to make digitized books available in electronic form, from the early Gutenberg Project to the most recent and heavily publicized Google undertaking.

As an example, in late 2003 Amazon.com released readable and searchable copies of over 100,000 books on its Internet web site, alongside its other web pages currently containing descriptive information on over three million additional books.

Advances in computer technology have rapidly reduced the cost of scanning or otherwise digitizing large numbers of books to very low levels, often being considerably less than the actual cost of purchasing single copies of those books. Standard data formats such as the web-optimized Adobe Portable Document Format (PDF) files provide a convenient means of displaying such digitized books, and the increasing availability of broadband connections remove any bandwidth obstacles to widespread use of such systems. Also, many millions of books have fallen out of copyright, and these can be made publicly available at will, a large project which Google, Microsoft, Yahoo, and other major companies are separately undertaking.

However, one major obstacle in transforming such large quantities of raw digitized book pages into actually useful information is a logical, inexpensive, and effective means of organizing, grouping, and presenting these partially or wholly digitized books.

Most of the existing systems for presenting books on the Internet either provide no such organizational structure, simply making them available through the results of general search processes based on title, author, text or otherwise, or else use very crude and broad subject categories.

One difficulty in providing a more intelligent organization of digitized books has been the vast human scale of such an undertaking: reading, analyzing, and subsequently categorizing even merely tens of thousands of books would require many thousands of man-years of high quality intellectual labor. Furthermore, the enormous subjective factor in such critiques could easily lead to reasonable charges of bias or other disputes.

Another problem is that many books from the past deal with specialized topics or issues which have largely faded from current knowledge. Few, if any, individuals today may possess the relevant knowledge or training to properly evaluate or summarize these books.

These difficulties in properly organizing or analyzing millions of old books represent an enormous limitation in their effective present-day use. Most current search engine systems such as Google rely upon analyzing the links provided by current Internet users to organize and rank the importance of Internet-based information, and to the extent that few if any present day users might initially locate, evaluate, and link to a digitized book, that book remains almost invisible to search engine users, whether or not it is actually freely available somewhere on the Internet in digitized form. This also appears to be one of the difficulties hindering widespread use of the vast number of digitized books freely available since 2003 in the Amazon system.

Under this current situation, the effective utility of most Internet-based digitized books is hardly greater than if they were still only available in hard-copy form, buried deep within the bowels of the major research libraries.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows a block diagram representing digitized books, with the additional electronic documents interlinked with them, in an example embodiment.

FIG. 1B, FIG. 1C, and FIG. 1D present screen-capture shots of several HTML summary web pages from an example embodiment.

FIG. 2 shows the structure of a portion of the database schema that may be used to implement this system of cross-linked digitized content items and digitized reviews of those content items for an example embodiment.

FIG. 3 shows a subset of the values for four records of a database table in a particular example of this embodiment.

FIG. 4 shows a block diagram representing an example production process for an example embodiment in which several of the operations may be performed in parallel.

FIG. 5 shows a block diagram representing an expanded view of an example production process for step 418 of FIG. 4.

FIG. 6 illustrates a computer system upon which an embodiment may be implemented.

### DETAILED DESCRIPTION

Organizing digitized content on the Internet through digitized content reviews is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In an embodiment, a method comprises creating and storing, in a database, first records representing reviews of one or more content items, wherein each of the first records comprises a field or associated index which directly or indirectly uniquely specifies a list of content item identifiers for content items that are reviewed in the review of that record; creating and storing, in the database, second records representing the content items, wherein each of the second records comprises a field or associated index which directly or indirectly uniquely specifies a list of review item identifiers for reviews that review the content item of that record; receiving, from a requesting computer, a request to display a summary web page associated with one of the reviews; in response to the request, generating a summary web page and providing the summary web page over a network to the requesting computer, wherein the summary web page comprises descriptive information about the requested review, and zero or more hyperlinks to electronic files that store the digitized forms of the content items identified in the second records, wherein the hyperlinks are dynamically generated based on the content item list uniquely specified by the first record. In an embodiment, a database stores records of reviews that are massively cross-linked to records of content items reviewed in the reviews, and pages can be dynamically generated to display the reviews and links to digitized files containing the reviews and the reviewed content items.

In an embodiment, generating the summary web page further comprises generating the summary web page comprising an additional hyperlink to an electronic file that stores a digitized text of the requested review. In an embodiment, generating the summary web page further comprises generating the summary web page comprising additional hyperlinks to summary web pages associated with the content items reviewed in the requested review.

In an embodiment, generating the summary web page further comprises generating the summary web page comprising the first hyperlinks that are sorted. In an embodiment, creating and storing the first records representing the reviews comprises creating and storing the first records representing reviews that were originally published in periodicals of different ideological perspectives and historical eras.

In an embodiment, the creating and storing comprises creating and storing, in the database, the first records representing the reviews of one or more visual media items and the second records representing corresponding visual media items. In an embodiment, the creating and storing comprises creating and storing, in the database, the first records representing the reviews of one or more audio media items and the second records representing corresponding audio media items.

In an embodiment, creating and storing the first records representing the reviews comprises creating and storing the first records representing reviews that were originally published only in printed form.

In an embodiment, the method further comprises receiving, from the requesting computer, a second request to display one of the content items; in response to the second request, generating a second summary web page and providing the second summary web page over the network to the requesting computer, wherein the second summary web page comprises second descriptive information about the requested content item and one or more third hyperlinks to third electronic files that store digitized texts of the reviews identified in the second records, wherein the third hyperlinks are dynamically generated based on the review item list uniquely specified by the second record.

In an embodiment, generating the second summary web page further comprises generating the second summary web page comprising one or more fourth hyperlinks to one or more fourth electronic files that store the requested content item. In an embodiment, generating the summary web page further comprises generating the summary web page comprising additional hyperlinks to summary web pages associated with the review items reviewing the requested content item.

In other embodiments, the invention encompasses a computer apparatus and a computer-readable medium configured to carry out the foregoing steps.

The present invention presents digitized books, periodicals, music, movies, or other audiovisual works, publications or content items on the Internet by an organizational system which associates, for example, a given digitized book with digitized copies of the published reviews of that book. In an embodiment, the reviews are drawn from as large and varied a collection of print publications as possible. Thus, in an embodiment, a diverse spectrum of reviews is used.

Unlike the user or web reviews provided on Amazon.com and numerous other Internet websites, these reviews are digitized from a previously printed form, external to the website, and hence can easily date back a century or more prior to the creation of the Internet, thereby encompassing a vastly greater number of books. Also, unlike the ubiquitous, casual, and frequently anonymous “user reviews” provided on many websites, these digitized print reviews derive their considerable independent credibility from that of their often-prominent authors and the respected publications in which they originally appeared.

Such a methodology allows the natural organization of a considerable fraction of all the higher-quality and more significant books ever published while minimizing the risk of having the organizational structure compromised by a single biased or idiosyncratic individual reviewer. Furthermore, the cost of digitizing and associating these existing published reviews is negligible compared with the cost of producing new reviews.

Under an example embodiment of this invention, the entire content of a book is made available on the Internet in digitized form, such as in a large web-optimized, text-embedded PDF file. Being in such format, this book and any of its pages is easily read, searched, resized, or printed through a standard web-browser. In other embodiments, the book content is made available through data processing networks other than the Internet; indeed, any network arrangement may be used. Furthermore, other embodiments may use digital data formats other than web-optimized, text-embedded PDF.

The web-optimized, text-embedded PDF file format automatically allows digitization of books containing colors or diagrams, though these features add to the size of the file and the bandwidth requirements. Also, web-optimized PDF files allow clients to retrieve and read individual pages of a large digital document, without the need to transfer the entire large PDF file over the Internet. And use of such industry-standard PDF format tends to minimize the expense of the digitization process.

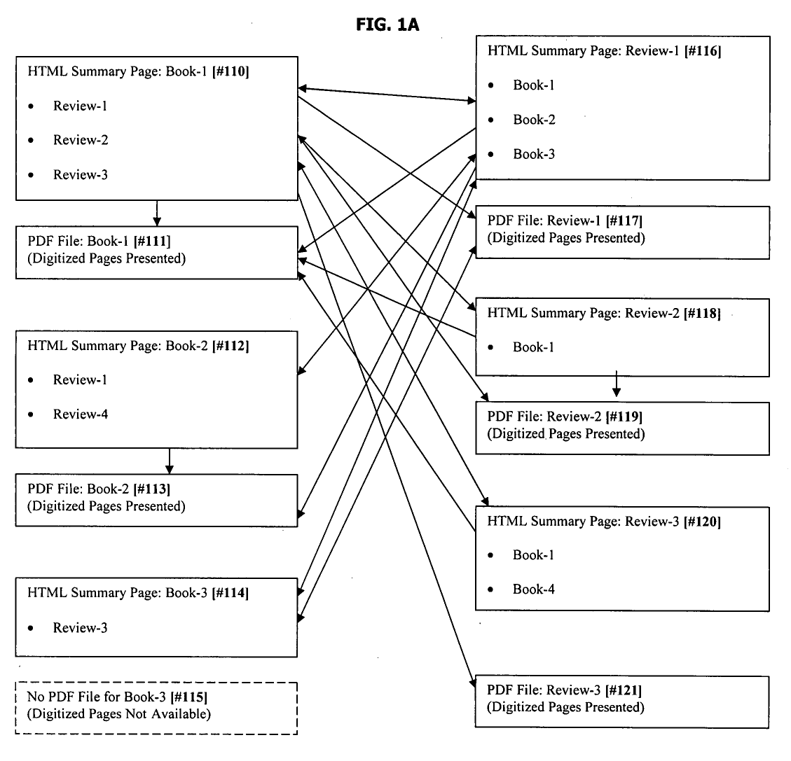

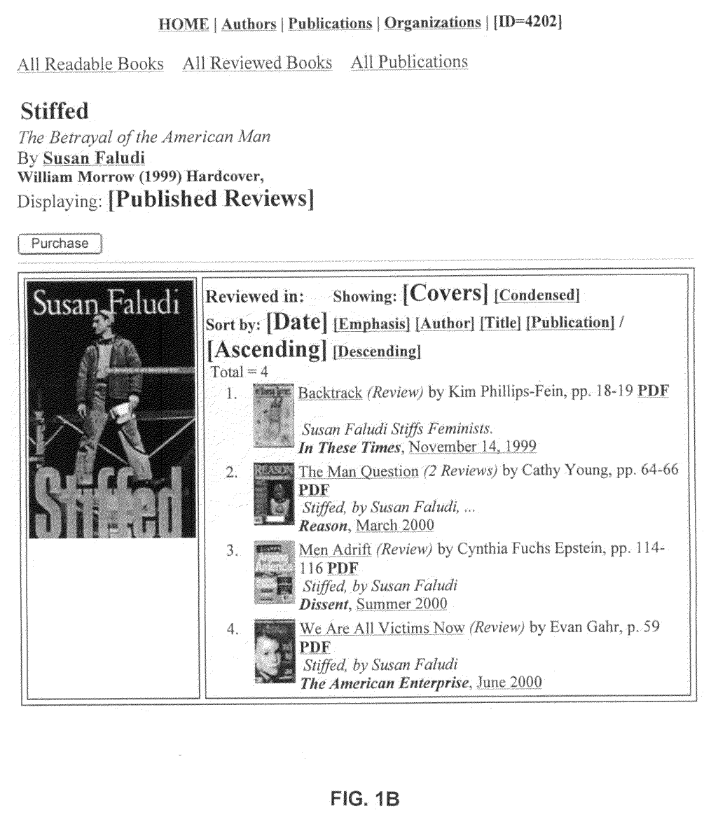

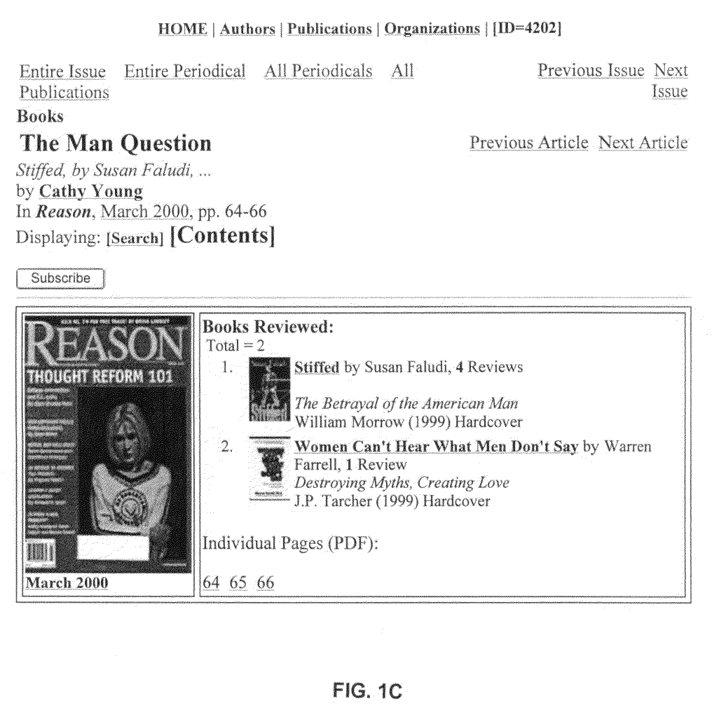

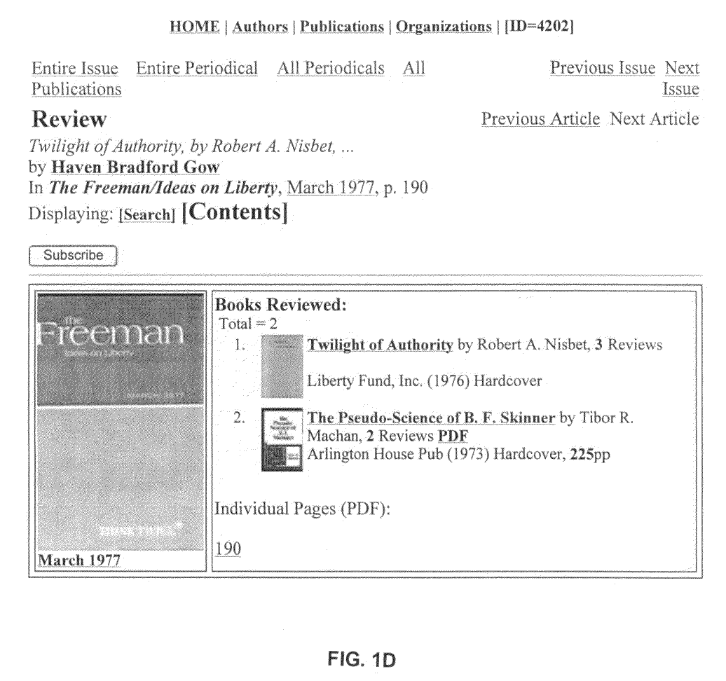

FIG. 1A shows a block diagram representing such digitized books in an example embodiment of this system, together with the additional electronic documents interlinked with them. For purposes of illustrating a clear example, the following description refers to digitized books. However, alternative embodiments are not limited to digitized books and alternate embodiments can interoperate with any form of digitized content. As one non-limiting example, embodiments may be used with digitized music and reviews of digitized music, or other digitized audio media items such as books on tape, books on CD, speeches, lectures, etc. Embodiments also may be used with any kind of visual media items such as movies, documentaries, how-to films, short video clips, etc.

Each of the digitized books provided in PDF format [#111,113] is also associated with a set of one or more HTML summary web pages [#110,112], containing links to one or more portions of the PDF file, as well as displaying a minimal summary description of the book, perhaps including its title, author, and publication information. These same HTML summary web pages [#114], but without the associated PDF link, may be present for books whose digitized contents are not currently available [#115] for legal or practical reasons. In alternative embodiments, electronic documents other than HTML web pages are used for the summary pages.

The HTML summary web pages [#110,112,114] associated with these books also contain listings of one or more published book reviews which are available in digitized form, including a description of these reviews, such as the author, title, and publication. Each review listing also is associated with links to electronic documents such as PDF files [#117,119,121] of the digitized book reviews and also to any HTML summary web pages [#116,118,120] that are associated with each of the digitized book reviews. The associated HTML book review pages each contain links to the available PDFs and HTML web pages for all of the books covered in that article review, well as to the PDF of the review itself.

Therefore, under this embodiment of the invention, available published reviews of a given book are grouped together as links on an HTML web page, as are the books discussed in a single review article. For example, Book-1 [#111] is discussed in Review-1 [#117], Review-2 [#119], and Review-3 [#121], and therefore the Book-1 HTML summary page [#110] contains links to the HTML summary pages for these three reviews [#116,118,120]. Since Review-3 also discusses Book-2 and Book-3, its HTML summary page [#120] contains links to the HTML summary pages of all three of these books [#110,112,114]. This cross-linkage serves to automatically associate Book-1 with Book-2 and Book-3 since all three books were discussed in the same Review-1, and therefore are probably related to some extent.

This cross-linking effect is intended to maximize the ease by which a given user can examine the contrasting reviews of a given book and also discover other books discussed in the same review, and hence which are somewhat related to the book initially being considered.

The HTML summary web pages are dynamically created upon request from a requesting computer using templates that are programmed in a web application language, such as ColdFusion, and draw their data from a relational database, such as MySQL, which contains the authors, titles, and other information on all the available books and their book reviews. The Internet page requests are managed by a web server, such as the Apache web page server.

This dynamic HTML implementation allows both the book and book review web pages to have their displayed links sorted by author, date, title, publisher, or other relevant information. Among other benefits, such sorting would easily allow readers to focus on those published reviews for a book which originally appeared in a particular time period.

FIG. 1B, FIG. 1C, and FIG. 1D present screen-capture shots of several HTML summary web pages from an example embodiment of this system.

In this embodiment, these particular HTML pages may be reached in a variety of different ways, including (1) through various higher-level HTML pages that allows users to search the system for books and periodical articles based on author, title, or other descriptive information; (2) via external Internet links such as those provided by bloggers or various other websites; or (3) through the results pages of major search engines such as Google and Yahoo once these search engines have indexed the pages of the website.

FIG. 1B presents an HTML summary web page for the book “Stiffed: The Betrayal of the American Man” by Susan Faludi, including a list of four review articles of that book appearing in Left periodicals Dissent and In These Times, the Libertarian periodical Reason, and the conservative periodical The American Enterprise. The summary page contains a large JPEG image of the book's cover, and the reviews contain small JPEG image of the cover of the magazine issue in which it appeared. Each review contains both a link to the HTML summary page of that review, as indicated by an underlined title such as “Backtrack,” and also a direct link to the PDF of that review article, as indicated by the underlined boldface label “PDF.”

For this particular embodiment, each review also contains a link to an HTML summary page for the entire issue of the periodical, as indicated by an underlined date such as “Nov. 14, 1999.” In addition, the displayed format of the HTML summary page may be modified by selected any one of several other links, with the sorted order of the reviews being controlled by “Author,” “Title,” and “Publication” links, and the “Condensed” link removing the small JPEG images, and displaying the reviews in a more condensed, pure text format. In addition, the “Purchase” button redirects the user to the Amazon.com page for the book, enabling its easy purchase.

FIG. 1C presents the HTML summary page for the Reason review listed in FIG. 1B, displaying a larger JPEG image of the magazine cover and smaller JPEG images of the covers of the two books reviewed in that article. The HTML summary page of FIG. 1C may be displayed, for example, by selecting the hyperlink associated with the review in the summary page of FIG. 1B (i.e., “The Man Question” hyperlink). Each of the books listed contains links to the HTML summary web pages for those books and would also contain links to the actual PDFs of the books themselves when and if they become available on the website. The underlined numbers “64”, “65”, and “66” near the bottom of the page represent links to the particular pages of the actual PDF of the review. In addition, the “Subscribe” button redirects the user to the subscription page for the particular magazine

FIG. 1D presents the HTML summary page for an article in The Freeman, a Libertarian periodical, reviewing the books “Twilight of Authority” by Robert A. Nisbet and “The Pseudo-Science of B. F. Skinner” by Tibor R. Machan. Since the second of these books is currently available on the website, the listing contains a link to the actual PDF of that book as indicated by the label “PDF”, which is not present for the first book.

In an example embodiment, the relational database underlying the dynamic web pages is designed as follows.

For each digitized book, periodical issue, or other content item added to the system, a database record is created and stored in the database. Each such record contains a unique data ID that also acts as a unique identifier for the digitized book, periodical issue, or other content item represented by the record.

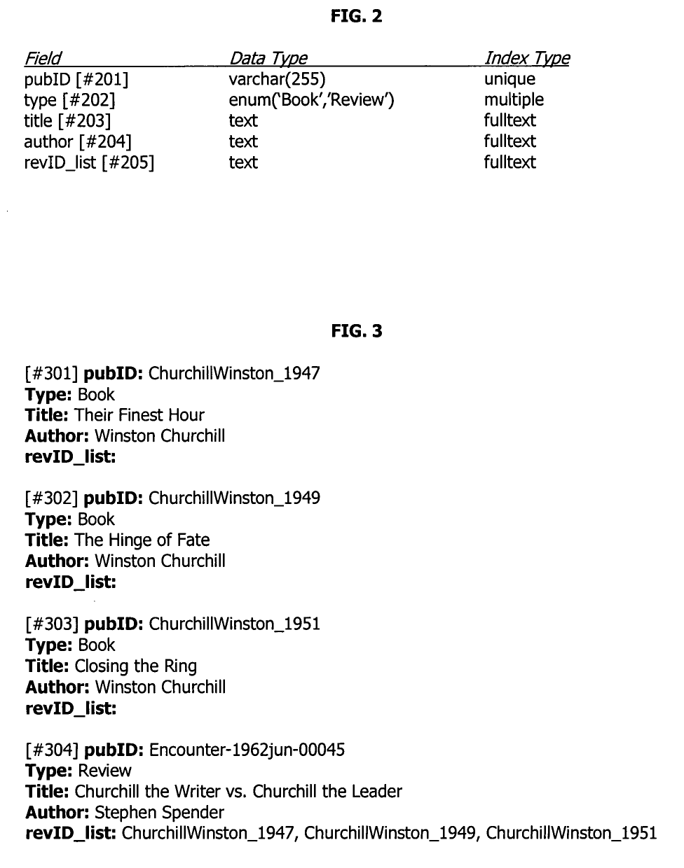

FIG. 2 shows the structure of a portion of the database schema that may be used to implement this system of cross-linked digitized content items and digitized reviews of those content items for an example embodiment based on the MySQL relational database.

For this example embodiment, each record in the relational database table contains a unique publication identifier pubID [#201] of type varchar(255), as well as text fields title [#203] and author [#204] containing the title and authors of the book or review article represented by that record. Also, each record contains an enum type field [#202] which is restricted to the values ‘Book’ (indicating that the record represents a book) or ‘Review’ (indicating that the record represents a review article). Finally, for review articles, the text field revID_list [#205] contains a comma-delimited list of the pubID values corresponding to all the books reviewed in that review article. The pubID field uses a unique index, the type field uses a non-unique index, and the title, author, and revID_list fields all use fulltext indexes.

In this embodiment, other portions of the database schema not shown in FIG. 2 may contain additional fields representing further descriptive and identifying information such as publication date, publisher, the ISBN number for books, ISSN number for periodicals. Alternatively, such information may be stored in a separate table that is linked or keyed to the table of FIG. 2 based on the pubID [#201].

During the process of generating the dynamic HTML summary page for a review article [#116], the values of list elements in the revID_list are used to generate queries that retrieve the descriptive information for the books corresponding to those elements. On the other hand, in generating the dynamic HTML summary page for a book [#110], a fulltext SQL query is performed on the revID_list field, thereby locating all those records which include a revID_list containing the pubID for that book; this is the list of all the reviews of that book.

In one embodiment, the pubID field for a digitized book may generally be derived by combining the first and last names of the first author, and appending an additional numerical suffix, necessary for uniqueness. For example, the unique pubID for a book written by Winston Churchill may be ChurchillWinston_{—}1947. In this embodiment, the unique identifier for a periodical article may be derived from the name of the periodical, the date of the issue, and the starting page of the article, so that the unique pubID identifier for an article beginning on p. 45 of the June 1962 issue of Encounter may be Encounter-1962jun-00045.

FIG. 3 shows a subset of the values for four records of a database table in a particular example of this embodiment. The first three records shown [#301-303] correspond to three books by Winston Churchill, entitled “Their Finest Hour,” “The Hinge of Fate,” and “Closing the Ring,” and are represented by the unique pubID index parameters ChurchillWinston_{—}1947, ChurchillWinston_{—}1949, and ChurchillWinston_{—}1951. The fourth record [#304] corresponds to a book review article by Stephen Spender entitled “Churchill the Writer vs. Churchill the Leader” published in the June 1962 issue of Encounter. Since the article reviews the three Churchill books, the article value of revID_list contains a comma-delimited list of the pubID values for those books.

An example process of producing this interlinked network of digitized books and book reviews is as follows.

First, the books and published reviews are converted into PDF files and made available on the Internet. Making digitized books and reviews available on the Internet may comprise, for example, storing the digitized books and reviews on a storage device or server that is directly or indirectly coupled to the Internet. During this digitization process, the descriptive information such as author, title, and publisher of the books and book reviews is also entered into the MySQL database, with each inserted record being indexed by a unique identifier,

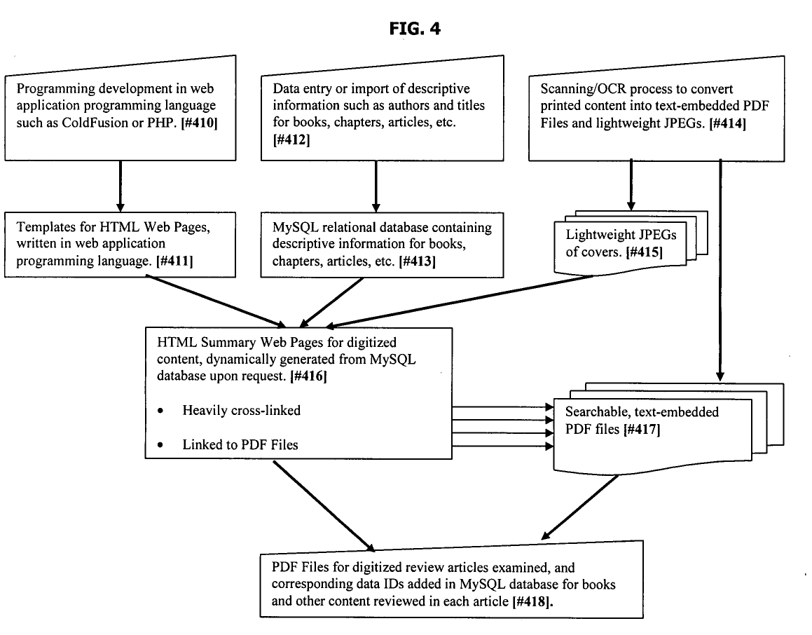

FIG. 4 shows a block diagram representing an example production process for an example embodiment of the invention, in which several of the operations may be performed in parallel.

Programming development in the web application language [#410] produces one or more templates [#411] that are used to dynamically generate the HTML summary Web Pages [#110,112,114,116,118,120]. Templates [#411] contain the basic design architecture of the system, including the specific layout and displayable views of the HTML summary web pages, as well as their links to each other, to the PDF Files, and to any external web pages. All such programming may be performed using Cold Fusion, PHP, or some other present or future web application language, using standard software programming techniques for the creation of dynamic web pages.

As shown in step 412, summary descriptive information on the digitized content is obtained either through data entry from the content itself or from an external database or other source and inserted into the underlying relational database [#413]. Standard database programming techniques may be used to insert such information. Step 412 may be performed in parallel with step 410. For various embodiments, such summary information might include the authors, titles, and starting pages of books, chapters, and articles. In the case of printed content, most of the summary information can usually be obtained from the table of contents page of the book or periodical issue.

Any printed content not already in binary image format may be scanned and digitized into such format using standard technologies, including OCR-processing to extract and embed ASCII versions of the text [#414]. Step 414 may be performed in parallel with steps 410, 412. For an example embodiment, the outputs of this processing are searchable text-embedded PDF files [#417], which constitute the digitized content files [#111,113,117,119,121] provided in this embodiment. In this example embodiment, the binary-images of the cover pages of the printed content are also separately extracted and compressed to produce lightweight JPEG graphical image files [#415] used for display on the HTML summary web pages.

Once these production processes have been completed, the generation of a given HTML summary web page [#416] draws upon the web application programming templates [#411], the descriptive information contained in the relational database [#413], and the lightweight graphical image files [#415], and may contain links to the appropriate PDF Files [#417].

Finally, the PDF files for the digitized review articles are examined to determine the books reviewed in each article, and the data IDs corresponding to those books are added to the database record for that article, determining the book/review article cross-linkages; any such reviewed books not already contained in the system are also inserted into the system database at this stage [#418].

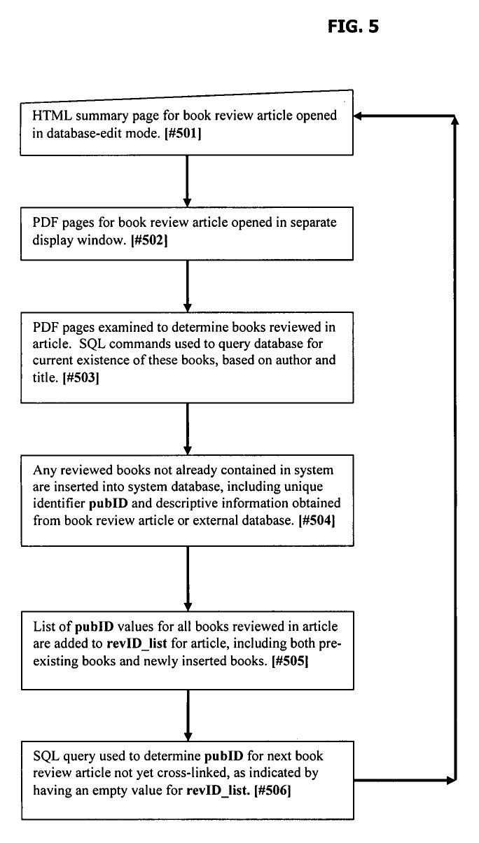

FIG. 5 shows a block diagram representing an expanded view of an example production process for this last stage [#418] of the digitization/database linkage production process, in which the books and book review articles are cross-linked.

First, a HTML summary page for the book review article being processed is opened, in a database-edit mode, which permits changes to be made to the values contained in the underlying relational database [#501]. Next, a separate window is opened displaying the PDF pages of that article, allowing the visual examination of its contents, including the books reviewed [#502].

After this, SQL database queries based on title and author are used to determine which if any of the reviewed books are not already contained within the database system [#503]. Records for any such absent books are inserted into the database, indexed by unique pubID identifiers and containing descriptive information obtained either from the book review itself or from some other, external database [#504].

Finally, the list of pubID values for all books reviewed in the article, whether pre-existing or newly created, is saved in comma-delimited form into the revID_list field of the review article [#505]. Another SQL query is then used to determine the pubID for the next review article to be processed (i.e. which still has an empty value for revID_list), and the HTML summary page for that article opened.

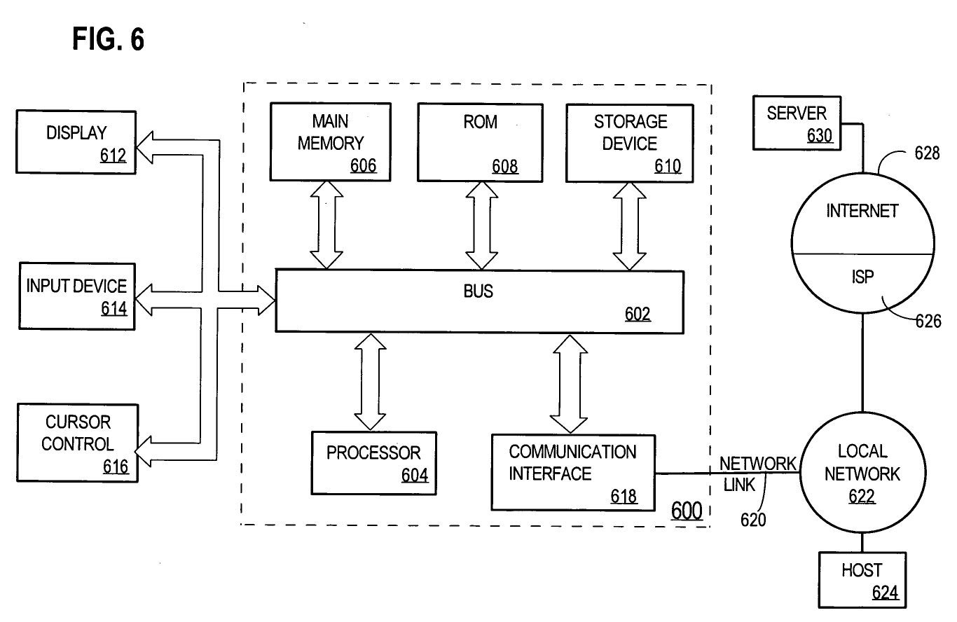

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (“RAM”) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (“ROM”) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (“CRT”), for displaying information to a computer user. An input device 614, including alphanumeric and other keys, is coupled to bus 602 for communicating information and command selections to processor 604. Another type of user input device is cursor control 616, such as a mouse, trackball, stylus, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for organizing digitized content on the internet through a broad spectrum of digitized content reviews. According to one embodiment of the invention, organizing digitized content on the internet through a broad spectrum of digitized content reviews is provided by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector can receive the data carried in the infrared signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (“ISDN”) card or a modem to provide a data communication connection to a corresponding type of telephone line. As another example, communication interface 618 may be a local area network (“LAN”) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (“ISP”) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. In accordance with the invention, one such downloaded application provides for organizing digitized content on the internet through a broad spectrum of digitized content reviews as described herein.

The received code may be executed by processor 604 as it is received, and/or stored in storage device 610, or other non-volatile storage for later execution. In this manner, computer system 600 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

For example, instead of being provided as a text-embedded single PDF file, the digitized books and book reviews could also be provided in some other format, such as being TIFFs, JPEGs, or some other present or future binary image format. In various embodiments, the page-images are displayed as stand-alone binary images or displayed within a lightweight webpage framework, such as an inserted image within the inline frame of an HTML page. These page-images could be bound together into a single file, provided separately, or exist as “Binary Large Objects” (BLOBs) inside a database.

Instead of being composed of simple HTML text, the web pages associated with the books and book reviews could be also rendered in XML or some other present or future lightweight, text format.

Instead of being based on ColdFusion, the templates used to produce the lightweight dynamic web pages might instead use some other present or future web application programming language, such as PHP. In addition, instead of MySQL, the underlying database system driving the creation of these dynamic web pages could instead rely on Oracle SQL, Microsoft SQL-Server, or some other present or future SQL or other relational database.

Instead of solely being using to organize books, the reviews could also be used to similarly organize other forms of reviewed content, such as films or music.

What is claimed is:

1. A method, comprising:
creating and storing, in a database, first records representing reviews of one or more content items, wherein each of the first records comprises a field or associated index which directly or indirectly uniquely specifies a list of content item identifiers for content items that are reviewed in the review of that record;
creating and storing, in the database, second records representing the content items, wherein each of the second records comprises a field or associated index which directly or indirectly uniquely specifies a list of review item identifiers for reviews that review the content item of that record;
receiving, from a requesting computer, a request to display a summary web page associated with one of the reviews;
in response to the request, generating a summary web page and providing the summary web page over a network to the requesting computer, wherein the summary web page comprises descriptive information about the requested review, and zero or more hyperlinks to electronic files that store the digitized forms of the content items identified in the second records, wherein the hyperlinks are dynamically generated based on the content item list uniquely specified by the first record.

2. The method of claim 1, wherein generating the summary web page further comprises generating the summary web page comprising an additional hyperlink to an electronic file that stores a digitized text of the requested review.

3. The method of claim 1, wherein generating the summary web page further comprises generating the summary web page comprising additional hyperlinks to summary web pages associated with the content items reviewed in the requested review.

4. The method of claim 1, wherein generating the summary web page further comprises generating the summary web page comprising the first hyperlinks that are sorted.

5. The method of claim 1, wherein creating and storing the first records representing the reviews comprises creating and storing the first records representing reviews that were originally published in periodicals of different ideological perspectives and historical eras.

6. The method of claim 1, wherein the creating and storing comprises creating and storing, in the database, the first records representing the reviews of one or more visual media items and the second records representing corresponding visual media items.

7. The method of claim 1, wherein the creating and storing comprises creating and storing, in the database, the first records representing the reviews of one or more audio media items and the second records representing corresponding audio media items.

8. The method of claim 1, wherein creating and storing the first records representing the reviews comprises creating and storing the first records representing reviews that were originally published only in printed form.

9. The method of claim 1, further comprising:
receiving, from the requesting computer, a second request to display one of the content items;
in response to the second request, generating a second summary web page and providing the second summary web page over the network to the requesting computer, wherein the second summary web page comprises second descriptive information about the requested content item and one or more third hyperlinks to third electronic files that store digitized texts of the reviews identified in the second records, wherein the third hyperlinks are dynamically generated based on the review item list uniquely specified by the second record.

10. The method of claim 9, wherein generating the second summary web page further comprises generating the second summary web page comprising one or more fourth hyperlinks to one or more fourth electronic files that store the requested content item.

11. The method of claim 9, wherein generating the summary web page further comprises generating the summary web page comprising additional hyperlinks to summary web pages associated with the review items reviewing the requested content item.

12. A computer-readable medium carrying one or more sequences of instructions, which instructions, when executed by one or more processors, cause the one or more processors to carry out the steps of:
creating and storing, in a database, first records representing reviews of one or more content items, wherein each of the first records comprises a field or associated index which directly or indirectly uniquely specifies a list of content item identifiers for content items that are reviewed in the review of that record;
creating and storing, in the database, second records representing the content items, wherein each of the second records comprises a field or associated index which directly or indirectly uniquely specifies a list of review item identifiers for reviews that review the content item of that record;
receiving, from a requesting computer, a request to display a summary web page associated with one of the reviews;
in response to the request, generating a summary web page and providing the summary web page over a network to the requesting computer, wherein the summary web page comprises descriptive information about the requested review, and zero or more hyperlinks to electronic files that store the digitized forms of the content items identified in the second records, wherein the hyperlinks are dynamically generated based on the content item list uniquely specified by the first record.

13. The computer-readable medium of claim 12, wherein the instructions which when executed cause generating the summary web page further comprise instructions which when executed cause generating the summary web page comprising an additional hyperlink to an electronic file that stores a digitized text of the requested review.

14. The computer-readable medium of claim 12, wherein the instructions which when executed cause generating the summary web page further comprise instructions which when executed cause generating the summary web page comprising additional hyperlinks to summary web pages associated with the content items reviewed in the requested review.

15. The computer-readable medium of claim 12, wherein the instructions which when executed cause generating the summary web page further comprise instructions which when executed cause generating the summary web page comprising the first hyperlinks that are sorted.

16. The computer-readable medium of claim 12, wherein the instructions which when executed cause creating and storing the first records representing the reviews comprise instructions which when executed cause creating and storing the first records representing reviews that were originally published in periodicals of different ideological perspectives and historical eras.

17. The computer-readable medium of claim 12, wherein the instructions which when executed cause creating and storing comprise instructions which when executed cause creating and storing, in the database, the first records representing the reviews of one or more visual media items and the second records representing corresponding visual media items.

18. The computer-readable medium of claim 12, wherein the instructions which when executed cause creating and storing comprise instructions which when executed cause creating and storing, in the database, the first records representing the reviews of one or more audio media items and the second records representing corresponding audio media items.

19. The computer-readable medium of claim 12, wherein the instructions which when executed cause creating and storing the first records representing the reviews comprise instructions which when executed cause creating and storing the first records representing reviews that were originally published only in printed form.

20. The computer-readable medium of claim 12, further comprising instructions which when executed cause:
receiving, from the requesting computer, a second request to display one of the content items;
in response to the second request, generating a second summary web page and providing the second summary web page over the network to the requesting computer, wherein the second summary web page comprises second descriptive information about the requested content item and one or more third hyperlinks to third electronic files that store digitized texts of the reviews identified in the second records, wherein the third hyperlinks are dynamically generated based on the review item list uniquely specified by the second record.

21. The computer-readable medium of claim 20, wherein the instructions which when executed cause generating the second summary web page further comprise instructions which when executed cause generating the second summary web page comprising one or more fourth hyperlinks to one or more fourth electronic files that store the requested content item.

22. The computer-readable medium of claim 20, wherein the instructions which when executed cause generating the summary web page further comprise instructions which when executed cause generating the summary web page comprising additional hyperlinks to summary web pages associated with the review items reviewing the requested content item.
